(19) United States
(12) Patent Application Publication
(10) Pub. No.: US 2014/0267003 A1
(43) Pub. Date: Sep. 18, 2014

(54) WIRELESS CONTROLLER TO NAVIGATE AND ACTIVATE SCREENS ON A MEDICAL DEVICE

(71) Applicant: FRESENIUS MEDICAL CARE HOLDINGS, INC., Waltham, MA (US)

(72) Inventors: Fei WANG, Concord, CA (US); Michael E. KOTSOS, Walnut Creek, CA (US); Martin J. CRNKOVICH, Walnut Creek, CA (US); Aiyuan WANG, San Ramon, CA (US)

(73) Assignee: Fresenius Medical Care Holdings, Inc., Waltham, MA (US)

(21) Appl. No.: 13/804,567

(22) Filed: Mar. 14, 2013

(51) Int. Cl. G06F 3/01

(52) U.S. Cl. CPC G06F 3/017
USPC 345/156

(57) ABSTRACT

A system provides non-contact communication between a controller and a medical device. The control signal may be a wirelessly transmitted control signal, such as a wireless radiofrequency signal and/or an optical or acoustic signal, for example. An interface device is provided that may be a remote controller or switch that may be used by a user, such as a health care practitioner (HCP), in connection with navigating and activating screens of a dialysis machine during a dialysis treatment without requiring the HCP to physically contact the dialysis machine. With the described system, the HCP does not need to re-glove each time a change is made to an on-going dialysis treatment when interfacing with a graphical display of the dialysis machine.

### TECHNICAL FIELD

This patent application is related to processing devices and interfaces in the medical device area.

### BACKGROUND OF THE INVENTION

Hemodialysis is a process which employs a machine that includes a dialyzer to aid patients whose renal function has deteriorated to the point where their body cannot adequately rid itself of toxins. The dialyzer may include a semi-permeable membrane, the membrane serving to divide the dialyzer into two chambers. Blood is pumped through one chamber and a dialysis solution through the second. As the blood flows by the dialysis fluid, impurities, such as urea and creatinine, diffuse through the semi-permeable membrane into the dialysis solution. The electrolyte concentration of the dialysis fluid may be set so as to maintain electrolytic balance within the patient. Other purification techniques and processes may additionally be used. Hemodialysis may be generally referred to herein as “dialysis,” although it is noted that other types of dialysis exist, such a peritoneal dialysis, and it is noted that the system described herein may be used in connection with any appropriate dialysis system or similar treatment system.

Since dialysis involves removing blood from and returning blood to a patient, performing a dialysis procedure carries a degree of risk. Dialysis treatment requires monitoring of several patient vital signs and dialysis parameters during the dialysis process in order to optimize the overall efficacy of the dialysis procedure, to assess the condition of a fistula (the access to the patient's blood) and to determine the actual purification achieved. Some examples of parameters monitored and analyzed by a dialysis machine or equipment include the blood access flow rate or the rate at which blood flows out of the patient to the dialyzer, a critical parameter; and the ratio Kt/V to measure dialysis efficiency, where K is the clearance or dialysance (both terms representing the purification efficiency of the dialyzer), t is treatment time and V is the patient's total water value.

A processing device coupled to the dialysis machine may be used to manage and oversee the functions of the dialysis process and to, for example, monitor, analyze and interpret patient vital signs and dialysis parameters during a dialysis procedure. The processing device may include a display that displays information concerning the dialysis procedure and include an interface that enables configuration and control of the dialysis machine. A health care practitioner such as a nurse or a patient care technician may oversee the dialysis treatment sessions. Data provided by the dialysis machine and the processing device may aid the health care practitioner in performing his or her duties.

For various descriptions of dialysis systems and components, reference is made, for example, to U.S. Pat. No. 8,110,104 B2 to Crnkovich et al., entitled “Dialysis Systems and Related Components,” and U.S. Pat. No. 6,775,577 B2 to Crnkovich et al., entitled “Method and System for Controlling a Medical Device,” which are incorporated herein by reference. For a description of a sensor system that may be used in connection with monitoring and issuing alerts during a dialysis procedure, reference is made, for example, to U.S. Pat. No. 7,973,667 B2 to Crnkovich et al., entitled “Wetness Sensor,” which is incorporated herein by reference. For various descriptions of interfaces for dialysis systems, reference is made, for example, to U.S. Pat. No. 8,323,503 B2 to Levin et al., entitled “User Interface Processing Device” and U.S. Patent App. Pub. No. 2007/0112603 A1 to Kauthen et al., entitled “Digital Data Entry Methods and Devices,” which are incorporated herein by reference.

An operator needs to re-glove after every patient interaction during a dialysis treatment, which often involves changing a graphical screen on the dialysis machine. The user may change screens as often as once every half hour during a typical dialysis treatment. Accordingly, it would be desirable to provide a system that efficiently and effectively enables a user, such as health care practitioner overseeing the dialysis treatment, to change the screens of the dialysis machine without having to touch or otherwise physically contact the dialysis machine.

### SUMMARY OF THE INVENTION

According to the system described herein, a method of non-contact interfacing with a medical device includes providing a first device that enables non-contact interfacing with the medical device by a user. A command signal is received from the user at the medical device, in which the command signal corresponds to a treatment performed using the medical device. The command signal is a non-contact command received from the user without physical contact of the user with the medical device. The command signal is processed at the medical device to generate information corresponding to the treatment performed using the medical device. The information is displayed on a screen of the medical device. The medical device may include a dialysis machine, and the information displayed on the screen of the medical device may include dialysis treatment information displayed during a dialysis treatment. The first device may include an interface device that transmits a wireless signal to the medical device in response to an action by the user. The non-contact command may cause a change in the information being displayed on the screen of the medical device which may include a different screen being displayed on the medical device and/or a section of the information being activated by the non-contact command. The method may further include recognizing a gesture of the user and/or a voice command of the user using a command recognition device coupled to the dialysis machine as the command signal.

According further to the system described herein, a non-transitory computer-readable medium stores software for non-contact interfacing with a medical device. The software includes executable code that operates a first device that enables non-contact interfacing with the medical device by a user. Executable code is provided that receives a command signal from the user at the medical device, wherein the command signal corresponds to a treatment performed using the medical device, wherein the command signal is a non-contact command received from the user without physical contact of the user with the medical device. Executable code is provided that processes the command signal at medical device to generate information corresponding to the treatment performed using the medical device. Executable code is provided that displays the information on a screen of the medical device. The medical device may include a dialysis machine, and the information displayed on the screen of the medical device includes dialysis treatment information displayed during a dialysis treatment. The first device may include an interface device that transmits a wireless signal to the medical device in response to an action by the user. The non-contact command may cause a change in the information being displayed on the screen of the medical device that may include a different screen being displayed on the medical device and/or a section of the information being activated by the non-contact command. Executable code may be provided that recognizes a gesture of the user and/or a voice command using a command recognition device coupled to the dialysis machine as the command signal. Executable code that recognizes a voice command of the user using a command recognition device coupled to the dialysis machine as the command signal.

According further to the system described herein, a system for enabling non-contact interfacing with a dialysis machine is provided. The system includes at least one sensor of the dialysis machine that receives signals corresponding to a dialysis treatment performed by the dialysis machine. A first device is communicationally coupled to the at least one sensor, wherein the first device includes at least one component that processes received signals into information corresponding to the dialysis treatment. At least one screen displays the information corresponding to the dialysis treatment. The first device includes an interface device that transmits a wireless signal to the medical device in response to an action by the user, wherein the wireless signal includes a command signal that causes a change in the information being displayed on the screen of the medical device. The change in the information being displayed on the screen of the medical device includes a different screen being displayed on the medical device and/or a section of the information being activated by the non-contact command. The first device includes a command recognition device that performs recognizing a gesture of the user a command recognition as the command signal and/or recognizing a voice command of the user as the command signal.

### BRIEF DESCRIPTION OF THE DRAWINGS

Embodiments of the system described herein are explained with reference to the several figures of the drawings, which are briefly described as follows.

FIG. 1 is a schematic illustration of an example of a patient care environment in which a patient seated in a chair receives medical treatment from a dialysis machine and which may be used in connection with an embodiment of the system described herein.

FIG. 2 is a schematic illustration of another example of a patient care environment that may be used in connection with an embodiment of the system described herein.

FIG. 3 is schematic illustration of an example implementation of the dialysis machine according to an embodiment of the system described herein.

FIG. 4 is a schematic illustration of a more detailed implementation of the dialysis machine according to an embodiment of the system described herein.

FIG. 5 is a schematic illustration of an interface device for a wireless controller that may be used in accordance with an embodiment of the system described herein.

FIG. 6 is a schematic illustration showing an embodiment of information that may be displayed on the display of the dialysis machine, that may be navigated using the interface device according to an embodiment of the system described herein.

FIG. 7 is a schematic illustration showing a health care practitioner using the interface device in connection with the monitoring and/or control of a dialysis treatment being performed in the patient care environment.

FIG. 8 is a schematic illustration showing another embodiment of the system described herein in which an interface device is configured for operation by a foot of the health care practitioner.

FIG. 9 is a schematic illustration showing another embodiment of the system described herein in the display of the dialysis machine may be controlled using gesture and/or acoustic control, such as voice-based control.

FIG. 10 is a schematic illustration showing a gesture by the health care practitioner that may be used to navigate and control one or more screens displayed on the display of the dialysis machine according to an embodiment of the system described herein.

FIG. 11 is a flow diagram showing processing steps in connection with non-contact control of a dialysis machine by a user with an interface device paired or otherwise coupled to the dialysis machine according to an embodiment of the system described herein.

FIG. 12 is a flow diagram showing processing steps for command recognition and information transmission processing in connection with the use of a command recognition device according to another embodiment of the system described herein.

FIG. 13 is a flow diagram showing processing in connection with navigating and/or activating screens of a display of a dialysis machine during a dialysis treatment according to an embodiment of the system described herein.

### DETAILED DESCRIPTION OF VARIOUS EMBODIMENTS

FIG. 1 is a schematic illustration of an example of a patient care environment 10 in which a patient 4 seated in a chair 6 receives medical treatment from a treatment station 22 and which may be used in connection with an embodiment of the system described herein. The medical treatment is, for example, dialysis. The treatment station 22 may be a dialysis treatment station or dialysis machine. A tube or blood line 8 transports blood from the patient 4 to the dialysis machine 22 and back again to the patient 4 after processing and treatment in the dialysis machine 22. The dialysis machine 22 with display 20 may be connected via cabling 18 to controller device 30 that may include a processor 14 which controls a touch screen display 12. In various embodiments, the display 20 may display information corresponding to a dialysis treatment being performed by the dialysis machine 22. The touch screen display 12 may be mounted on a movable stand 16 of the controller device 30. The touch screen display 12 may include a touch screen that permits a health care practitioner (HCP), such as a nurse, a patient care technician (PCT), or even a patient, to press the display 12 to, for example, to interface with and/or control the dialysis machine 22 and/or to enter patient or other data.

According to various embodiments of the system described herein, a sensor 40 may be coupled to the controller device 30 that may be used to control the dialysis machine 22 in connection with transmitting and/or receiving signals to or from a remote or external interface device, as further discussed in detail elsewhere herein. The sensor 40 may be wirelessly coupled to one or more wireless interface devices that may be used by a PCT to monitor and/or control a dialysis treatment being performed by the dialysis machine 22. Various embodiments for the one or more wireless interface devices and for the actions and functions of the sensor 40 in connection with control of the dialysis machine 22 are further discussed in detail elsewhere herein. It is noted that the system described herein may be used with any appropriate wireless communication technology, including, for example, IEEE 802.11b/g, 802.11b/g/n, and/or Bluetooth, having appropriate security and encryption standards, and used in conjunction with appropriate wireless networks, having hardware and software components, that support such wireless communication technologies.

FIG. 2 is a schematic illustration of another example of a patient care environment 100 that may be used in connection with an embodiment of the system described herein. In the patient care environment 100, the patient 4 is seated in the chair 6 and receives medical treatment from a treatment station, such as a dialysis machine 102. The tube or blood line 8 is used for transporting blood from the patient 4 to the dialysis machine 102 and back again to the patient 4 after processing and treatment of the blood in the dialysis machine 102. The dialysis machine 102 may be configured to communicate with an external network 120, such as a local-area network or the Internet, via a wired or wireless connection 124. The network 120 may include one or more databases or other stores of information that securely contain medical information that may be accessed in connection with operation of the system described herein. It is noted that the system described herein may be used in connection with dialysis products produced by Fresenius Medical Care North America of Waltham, Mass., including, for example, Fresenius hemodialysis systems (e.g., a 2008T system).

In an embodiment, the dialysis machine 102 may include a display 112 with touch screen features. The dialysis machine 102 may centralize and consolidate dialysis functions and data entry functions in a single device 102, without, e.g., the use of a separate, external display (e.g., display 12 of FIG. 1) or a separate, external processor (e.g., processor 14) with associated equipment (e.g., movable stand 16). In an embodiment, the dialysis machine 102 may include one or more processors 114, like the processor 14, that may be used in connection with interfacing with, and control of, the dialysis machine 102, for example, by an HCP during a dialysis treatment. Consolidation of functions in a single dialysis machine 102 may advantageously reduce the amount of external cabling (e.g., cabling 18) to the device 102. The dialysis machine 102 may further reduce the amount of space needed for dialysis treatment and present less crowding of the patient care environment 100. An HCP may be able to focus solely on the dialysis machine 102, or the display 112 of the dialysis machine 102, without the HCP's attention being diverted to, e.g., another external display. The dialysis machine 102 may reduce power consumption and cost as compared to other, non-centralized implementations.

In an embodiment, a sensor 140 may be coupled to the dialysis machine 102. As noted in connection with the sensor 40 of FIG. 1, and as discussed in detail elsewhere herein, the sensor 140 may be used in connection with receiving external or remote signals that may be used to control the dialysis machine 102 and/or may be transmit signals in connection with operation of the dialysis machine 102. In another embodiment, a sensor 140′, that may be like the sensor 140, but may be separate from the dialysis machine 140 and coupled wirelessly thereto. Further, the sensor 140′ may also be wireless coupled to the network 120. Accordingly, in various embodiments, functions of the sensor 140′ may include control of and/or information chance with the dialysis machine 102 via direct communication therewith and/or the sensor 140′ may interface with the dialysis machine 102 via the network 120. Further discussions of the features and functions of the sensor 140 and 140′ are discussed in detail elsewhere herein.

FIG. 3 is schematic illustration of an example implementation 200 of the dialysis machine 102 according to an embodiment of the system described herein. A user interface processing device (UIP) 206 may be configured to share user interface resources, i.e., user interface devices 208-1, 208-2, 208-3 . . . , 208-N, between a first processing device 202 and a second processing device 204. Both the first and the second processing devices 202, 204 may be connected to the UIP 206 via respective connections 210, 212, while the user interface devices 208-1, 208-2, 208-3 . . . , 208-N are connected to the UIP 206 via connections 214-1, 214-2, 214-3 . . . , 214-N. Although one UIP 206 is shown in FIG. 3, several user interface processing devices may be used to implement the functionality of the UIP 206. The UIP 206 is connected to memory 216 via a connection 218. Other memory (not shown) may be connected to, and, used by, e.g., the first processing device 202 and/or the second processing device 204.

The user interface devices 208-1, 208-2, 208-3 . . . , 208-N may include any of a variety of user interface devices known in the art, such as an alphanumeric keyboard or a keypad, a pointing device (e.g., a touchpad, a mouse, or a trackball), a display, and a display with a touch screen. In an implementation, one or more of the user interface devices 208-1, 208-2, 208-3 . . . , 208-N may be located external to the HD device 200, specifically user interface device 208-3 is shown remotely located and wirelessly coupled, via wireless connection 214-3, to the HD device 200. Various embodiments for a user interface device, like that of user interface device 208-3, being used to wirelessly monitor and/or control the dialysis machine 102 are further discussed in detail elsewhere herein.

The second processing device 204 of the HD device 200 may be configured to communicate with the external network 120, such as a local-area network or the Internet, via a wired or wireless connection 124 (and, e.g., via a network interface (not shown)). In other implementations, other processing devices such as the UIP 206 or the first processing device 202 may communicate with an external network such as the external network 120.

As described herein, the UIP 206 may be configured to share the user interface devices 208-1, 208-2, 208-3 . . . , 208-N between the first processing device 202 and the second processing device 204. The UIP 206 may switch focus from the first processing device 202 to the second processing device 204. The UIP 206 may likewise switch focus from the second processing device 204 to the first processing device 202. Specifically, a processing device, such as the first or the second processing device 202, 204 of FIG. 3, may be said to have focus when the processing device has control of, and/or is controlled by, one or more user interface devices connected to, or communicating with, the processing device (e.g., via one or more user interface processing devices). That is, in this example, when a processing device has focus, a user interface device connected to, or communicating with, the processing device (e.g., via one or more user interface processing devices) will generally affect operation of the processing device, and thereby the dialysis machine 102. User interactions with a user interface device will likewise generally affect operation of the processing device in this instance. Likewise, in this example, when a processing device has focus, the processing device may control a user interface device (such as a video display) connected to, or communicating with, the processing device (e.g., via one or more user interface processing devices).

When a processing device, such as the first or the second processing device 202, 204 of FIG. 3, does not have focus, then, for example, the processing device may not have control of and/or be controlled by one or more user interface devices connected to, or communicating with, the processing device (e.g., via one or more user interface processing devices). Rather, another processing device may have been given focus. One or more user interface processing devices such as the UIP 206 may send protocol data to the processing device, even when the processing device does not presently have focus, so that the processing device may be configured to maintain connections with one or more user interface devices. That is, from the perspective of the processing device, even when the processing device does not have focus, the processing device may have a connection maintained with a user interface device that the processing device does not control and/or that is not controlled by the processing device when the processing device does not have focus. The UIP 206 may therefore send protocol data related to the one or more user interface devices to the first and the second processing devices 202, 204, irrespective of which processing device 202, 204 has focus.

When a processing device (such as the first processing device 202 or the second processing device 204) has focus, one or more user interface processing devices (such as the UIP 206) may manage communications between one or more user interface devices (such as the user interface devices 208-1, 208-2, 208-3 . . . , 208-N) and the processing device. The UIP 206 may, when the processing device has focus, permit the user interface devices 208-1, 208-2, 208-3 . . . , 208-N to affect operation of the processing device. The UIP 206 may switch between modes. The modes may be exclusive of one another and may include a mode in which the first processing device 202 has focus, and a mode in which a second processing device 204 has focus.

According to various embodiments of the system described herein, one or more of the interface devices 208-1 to 208-N, such as the device 208-3, may include one or more remote interface devices wireless coupled to the dialysis machine 102 via a sensor, such as the sensor 40, 140 or 140′ discussed in FIG. 1 and/or FIG. 2. The remote interface device(s) 208-3 may include various embodiments and implementations of devices that may be used by a user (such as an HCP) in connection with the monitoring and/or control of the dialysis machine 102, as further discussed in detail elsewhere herein.

FIG. 4 is a schematic illustration of a more detailed implementation 300 of the dialysis machine 102 according to an embodiment of the system described herein. A UIP 306 is configured to share user interface resources, e.g., a keyboard 308, a pointing device 310 (such as a touchpad), a display 312 with a touch screen, and/or a remote interface device 400, between a first processing device 302 and a second processing device 304. The first processing device 302 may be a functional dialysis processing device (FHP) 302 that may be configured to monitor dialysis functions of the HD device 300. The second processing device 304 may be a microprocessor, such as a standard personal computer (PC) processor, embedded within the HD device 300, and may be referred to as an embedded processing device (EP) 304. The FHP 302 is connected to the UIP 306 via connections 322, 324, 326, 328, and the EP 304 is connected to the UIP 306 via connections 330, 332, 334, 336.

The keyboard 308 is connected to the UIP 306 via connection 338. The pointing device 310 is connected to the UIP 306 via connection 340. The display 312 is connected to a digital video switch 316 via connection 342, which is in turn connected to the UIP 306, the FHP 302, and the EP 304 via respective connections 344, 346, 348. A touch screen controller 314 is connected to the display 312 via connection 350, and to the UIP 306 via connection 352. Although one UIP 306 is shown in FIG. 4, several user interface processing devices may be used to implement the functionality of the UIP 306. The UIP 306 is connected to memory 358 via a connection 360. Other memory (not shown) may be connected to, and, used by, e.g., the FHP 302 and/or the EP 304. The EP 304, for example, may utilize a flash memory rather than a conventional hard drive. The HD device 300 also includes an audio device 362. The audio device 362 is connected to the EP 304 via connection 364 and the UIP 306 via connection 366. FIG. 4 is intended to show functional connections between devices of the HD device 300, so more or fewer connections may be used than are shown in FIG. 4.

As described above, the UIP 306 may switch focus from the FHP 302 to the EP 304. The UIP 306 may likewise switch focus from the EP 304 to the FHP 302. When the FHP 302 has focus, one or more of the keyboard 308, the pointing device 310, the display 312 with a touch screen will generally affect operation of the FHP 302. When the EP 304 has focus, the keyboard 308, the pointing device 310, the display 312 with a touch screen, and/or the remote interface device 400 may generally affect operation of the EP 304. User interactions with the devices 308, 310, 312, 400 will likewise generally affect operation of whichever processing device (the FHP 302 or the EP 304) has focus. The processing device that has focus (the FHP 302 or the EP 304) may control, e.g., the display 312 in certain circumstances.

In various implementation, one or more of the user interface devices may be located external to the HD device 300. In this example implementation, when the EP 304 has focus, the FHP 302 does not have focus, and the FHP 302 may not have control of and/or be controlled by the devices 308, 310, 312, 400. When the FHP 302 has focus, the EP 304 does not have focus, and the EP 304 may not have control of and/or be controlled by the devices 308, 310, 312, 400. The UIP 306 may send protocol data relating to the devices 308, 310, 312 to the EP 304 and the FHP 302, even when one of these devices does not have focus, so that the EP 304 and the FHP 302 may maintain connections with the devices 308, 310, 312. That is, from the perspective of the processing device (EP 304 or FHP 302) that does not have focus, a connection at least appears to be maintained with the devices 308, 310, 312, 400, even though these devices 308, 310, 312, 400 are not controlled by, and do not control, the processing device that does not have focus. The UIP 306 may therefore send protocol data related to the devices 308, 310, 312, 400 to the FHP 302 and the EP 304, irrespective of which processing device 302, 304 has focus. The UIP 306 may switch between modes. The modes may be exclusive of one another and may include a mode in which the first processing device 302 has focus, and a mode in which the second processing device 304 has focus.

In accordance with the system described herein, it is noted that systems and techniques are known for providing wireless devices that may enable wireless coupling of a switch or controller with a base device or computer. The control communication between the controller and the base device may be a wirelessly transmitted control signal, such as a wireless radiofrequency signal and/or an optical or acoustic signal, for example. The system described herein may be used in connection with any appropriate remote control signal and mechanism to enable one device to wirelessly send instructions to another device.

FIG. 5 is a schematic illustration of an interface device 401 for a wireless controller that may be used in accordance with an embodiment of the system described herein. The interface device 401 may be an embodiment of the device 400 described in FIG. 4. The interface device 401 may be a switch used by a user, such as an HCP, in connection with navigating and/or activating screens of a dialysis machine, such as the dialysis machines 22, 102 and/or the controller device 30, during a dialysis treatment in a non-contact manner, as further discussed in detail elsewhere herein.

The interface device 401 may include a control portion 410 and an indicator portion 415. The control portion 410 may include one or more buttons or keys that may be pressed by a user to wirelessly select and/or otherwise cause activation of elements on a display screen of a dialysis machine, such as the display 112 of the dialysis machine 102, without requiring the user to touch or otherwise physically contact any other device or component being used in connection with a dialysis treatment of patient. When one or more of the keys on the control portion 410 are pressed, a wireless command is sent to the dialysis machine 102 and received by the sensor 140 or the sensor 140′. The wireless command may be used to navigate through the screens on the display 112. In an embodiment, the screens on the display 112 may switched in a pre-defined order and/or a user may cycle through activatable portions of any one screen in a pre-defined way using one or more of the buttons of the control portion 410. In another embodiment, where the control portion 410 of the interface device 401 has multiple keys, each key may be assigned be assigned to a particular screen, such that dedicated screens are associated with dedicated keys.

The indicator portion 415 may include one or more indictors, such as lights, that may communicate a successful pairing of the interface device with the sensor 140, of the dialysis machine 102 and/or with the remote sensor 140′ communicating with the dialysis machine 102. The indicators of the indicator portion 415 may further communicate other information, such as low battery and/or other information concerning the communication pathway between the interface device 401 and the dialysis machine 102.

The interface device 401 may include a transceiver device 420 that receives and/or transmits signals according to the functionality discussed herein. The transceiver device 420 may include one or more processors to process signals in connection in connection with the transmission of instructions for remotely controlling the dialysis machine 102. The transceiver device 420 may further include a memory, and/or other non-transitory computer-readable media, to store data in connection with the information transmitted and/or received by the interface device 401 and in connection with the execution of software or other executable code in connection with the operations of the interface device 401. The interface device 401 may further include a power source 430, such as a battery.

The interface device 401 may be configured for operation by a user's hand and/or may be placed on the floor and operated by a user's foot. In an embodiment, the interface device 401 may be paired with the dialysis machine 102 to provide that only the interface device 401 is wirelessly controlling the dialysis machine 102. The interface device 401 may receive certain information wirelessly transmitted by the sensor 140 or the sensor 140′, for example, in connection with pairing or authenticating the interface device 401 with the dialysis machine 102, and/or in connection with acknowledging control signals sent by the interface device 401 to the dialysis machine 102 to control the display 112 thereof as discussed herein.

FIG. 6 is a schematic illustration showing an embodiment of information 500 that may be displayed on the display 112 of the dialysis machine 102, that may be navigated using the interface device 401 according to an embodiment of the system described herein. The illustrated embodiment of the information 500 is presented by way of example only, and other information, particularly other operational functions and features for controlling and/or monitoring a dialysis treatment, may be displayed and/or controlled in accordance with the system described herein. In the illustrated embodiment, the information 500 may include a treatment screen on the display 112 of the dialysis machine 102 that incorporates the methods and systems for monitoring and/or controlling functions of the dialysis machine 102 that are discussed herein. Other systems and interfaces may also be used for controlling a dialysis machine and/or other medical device, and reference is made, for example, to U.S. Pat. No. 6,775,577 to Crnkovich et al., entitled “Method and System for Controlling a Medical Device,” which is incorporated herein by reference.

Screen access buttons 502 (main access), 504 (trends), 506 (dialysate), 508 (test options), 510 (heparin), 512 (Kt/V), 514 (BTM), and 516 (blood pressure) may be used to access the various treatment screens in a manner that may be similar to that accessed at the display 112, for example, via touch screen functionality of the display 112. For example, as shown in FIG. 6, the main access button 502 has been activated using the interface device 401, revealing a main treatment access screen 501 that may be displayed on the interface device 401 and on the display 112 of the dialysis machine. It is noted that, in other embodiments, different and/or summarized versions of the information displayed on the display 112 of the dialysis machine 102 may be displayed on the interface device 401. A different treatment access screen may be displayed, for example, by pressing the different screen access buttons. The main treatment access screen 501 provides a general overview of the status of the current treatment. Other treatment screens may offer a more in-depth view of specific aspects of the current treatment, though some treatment screens may have some of the same information displayed as found on other treatment screens.

A status box 518 appears at the top left corner of the treatment screen being displayed in the information 500. During normal operation it displays the operation mode of the machine, which in this case is “Dialysis.” During alarm situations, a warning message may be displayed in the status box 518. The message displayed in the status box 518 may also prompt the operator for a specific action in situations when the treatment parameters are being set. During normal treatment, a box 520 displays the current time and the box 522 displays the time of the last blood pressure reading and the patient's blood pressure and pulse rate at that time. Arterial pressure in mmHg is displayed numerically in a meter box 524, and graphically in a bar graph 526. Similarly, venous pressure in mmHg is displayed numerically in a meter box 528 and graphically in a bar graph 530, and transmembrane pressure (TMP) in mmHg is displayed numerically in a meter box 532 and graphically in a bar graph 534.

A Tx clock button 536 may be activated start, or to pause or suspend, the treatment. The Tx clock button 536 controls multiple functions of the hemodialysis machine when it is activated. A UF-goal button 538 displays the desired ultrafiltration (UF) in milliliters to be removed during the dialysis treatment. This is typically the difference between the patient's pre and dry weight plus saline or fluid intake during treatment. The UF-time button 540 acts as a countdown timer displaying the remaining time in hours and minutes that ultrafiltration will be performed. The timer stops during a blood alarm or whenever the UF pump is stopped. During treatment, A UF-rate button 542 displays the current rate of ultrafiltration in milliliters per hour. The rate ultrafiltration occurs is determined by the values entered in a UF-goal button 538 and a UF-time button 540 and the profile selected with a UF-profile button 546. A UF-removed button 544 keeps a running total in milliliters of the fluid drawn from the patient through ultrafiltration. When the value displayed in the UF-Removed button 544 is equal to the value entered in the UF-goal button 538, an alarm sounds and the message, “UF GOAL REACHED” is displayed in the status box 518. A UF-profile button 546 when touched brings up the UF Profile selection screen. Once a profile is selected, and the operator pushes the main access button 502, the profile selected is displayed in the UF-profile button 546.

A dialysate flow button 548 displays the current dialysate flow rate in milliliters per minute. A temperature button 550 displays the current temperature in degrees centigrade of the dialysate. Pressing the temperature button 550 allows the operator to set the desired temperature, and thereafter the actual temperature is displayed. If the temperature varies too far from the set point, an alarm sounds, a warning message is displayed in the status box 518, and the dialysate goes into bypass. A conductivity button 552 displays the current conductivity in millisiemens per centimeter of the dialysate. An RTD (Remaining Time of Dialysis) button 554 acts as a countdown timer displaying the amount of treatment time remaining. At the end of treatment (RTD=0:00) an alarm sounds and the message “RTD ZERO” is displayed in the status box 518. An SVS profile button 556 when touched brings up the Sodium Variation System (SVS) profile selection screen. Once a profile is selected, and the operator pushes the main access button 502, the profile selected is displayed in the SVS profile button 556.

In various embodiments, commands recognized by the interface device 401, such as gesture and/or voice commands, may be used to control functionality of the treatment screen being displayed as information 500 on the interface device 401. Accordingly, the mechanism of control of the treatment screen may deviate from control of the treatment screen that is being displayed on the display 112 of the dialysis machine 102. For example, whereas the display 112 on the dialysis machine 102 is controlled by touch screen functionality, treatment screen displayed on the screen 410 of the interface device 401 may be controlled, for example, by the command-based recognition that may be used to iterate through and/or highlight different buttons of the information 500 for the treatment screen that is being displayed on the screen 410. As discussed elsewhere herein, in other embodiments, the information 500 being displayed on the interface device 401 may present a treatment screen that is somewhat different from the treatment screen presented on the display 112 of the dialysis machine 102 in a manner that facilitates that command-based recognition control enabled by the interface device 401.

FIG. 7 is a schematic illustration 600 showing an HCP 650 using the interface device 401 in connection with the monitoring and/or control of a dialysis treatment being performed in the patient care environment 100 (see, e.g., FIG. 2). In this embodiment, the HCP is shown holding the interface device 401. The interface device 401 enables the HCP 650 to control the dialysis machine 102 during the dialysis treatment in a non-contact manner without requiring the HCP to touch and/or otherwise contact the dialysis machine 102 or component thereof. In this way, the HCP does not need to re-glove each time an action needs to be taken with respect to the dialysis machine 102, such as modifying a parameter thereof during the dialysis treatment. By pressing the buttons of interface device 401, the HCP may navigate through screens being displayed on the display 112 of the dialysis machine and/or may select and/or activate portions of the information 500 being displayed. The wireless control signal transmitted from the interface device 401 is shown schematically as signal 421 from the interface device 401. Further shown schematically are wireless signals 141, 141′ that may be transmitted from the sensor 140 or the sensor 140′. For example, the signal 141 may be a pairing signal and/or acknowledge signal sent from the sensor 140 and received by the interface device 401. The signal 141′ of the sensor 141 that is positioned separately from the dialysis machine 102 may be a signal relayed via the network 120 in connection with operation of the system for the embodiment where the sensor 141 is used. Using the interface device 401, the HCP 650 may control the dialysis machine during the dialysis treatment without contacting the display 112 of the dialysis machine 102.

FIG. 8 is a schematic illustration showing another embodiment of the system described herein in which an interface device 402, that is like the interface device 401 and having similar components, is configured for operation by a foot of the HCP 650. In this embodiment, a control portion 410′ of the interface device 402 may have a different configuration of the buttons for suitable activation by the foot of the HCP 650. For example, the buttons of the control portion 410′ may be bigger or oriented in way that facilitates foot control. In an embodiment, by pressing buttons of the control portion 410′ of the interface device 402 by foot, the HCP 650 may navigate through screens of the dialysis machine 102 in a pre-defined order and may activate portions of the screens (e.g., the information 500) being displayed on the screen in a controlled way without having to physically contact the dialysis machine 102.

FIG. 9 is a schematic illustration showing another embodiment of the system described herein in the display 112 of the dialysis machine 102 may be controlled using gesture and/or acoustic control, such as voice-based control. In this embodiment, rather than the HCP engaging a remote device, a sensor 142 coupled to the dialysis machine 102 includes a command recognition device 145 that may recognize gesture and/or voice control by the HCP 650. The sensor 142 may operate similarly to the sensors 140 and/or 141 except that the sensor 142, via the device 145, recognizes and interprets non-contact commands of the HCP 650 in connection with selection, control and activation of elements of the information 500 being displayed on the display 112 of the dialysis machine 102. It is also specifically noted that this embodiment may also be combined with use of the interface device 401. The command recognition device 145 may also be disposed elsewhere on the dialysis machine 102, including to the left or right of the display 112 or behind the display 112 in a manner that facilitates the command recognition (e.g. gesture and/or voice-based recognition) and appropriately coupled to the sensor 140 and/or the display 112.

In various embodiments, the commands recognized by the command recognition device 145 of the sensor 142 may be gestures recognized and used by a gesture-recognition module of the command recognition device 430 in connection with the operation of the interface device 401 may include, for example, hand gestures, head gestures and/or eye gestures of the user. In other embodiments, the command recognition device 430 may include a voice recognition module that enables voice-based control of the interface device 401. The command recognition capability thereby enables hands-free, non-contact operation of the interface device and remote control of the dialysis machine according to the system described herein. Multiple techniques and systems are known for providing non-contact command recognition capability, including gesture and/or voice based command recognition, and reference is made, for purposes of illustrative and descriptive example only, to U.S. Pat. No. 8,228,315 to Starner et al., entitled “Methods and Systems for a Virtual Input Device,” and U.S. Pat. No. 8,223,088 to Gomez et al., entitled “Multimode Input Field for a Head-Mounted Display,” which are incorporated herein by reference.

FIG. 10 is a schematic illustration 700 showing a gesture 710 by a user (HCP) that may be used to navigate and control one or more screens displayed on the display 112 of the dialysis machine 102 according to an embodiment of the system described herein. The gesture 710 is recognized by the command recognition device 145 of the sensor 142 coupled to the dialysis machine 102. The display 112 shows the information 500 in which a section 502a has been activated by the gesture 710, as recognized by the command recognition device 145. The activated section 502a may be a button, such as the main access button 502 (see FIG. 6) that activates the providing of a main access treatment screen 501 to provide a general overview of the status of a current dialysis treatment being performed. The providing of the main access treatment screen 501 may be performed by the activation instruction of the button 502 according to the interpretation of the gesture 710 by the user that is processed by the sensor 142. It is also explicitly noted that the sensor 142 may also be configured as a separate sensor, like the sensor 140′ discussed elsewhere herein, and which signals are communicated from the sensor 142 to the dialysis machine 102 via the network 120 (see FIG. 2). As further discussed elsewhere herein, the command recognition device 145 of the sensor 142 may also include a voice-recognition component that enables voice-based control, instead of or in addition to gesture control, by the user to navigate the information 500 displayed on the display 112 of the dialysis machine 102.

FIG. 11 is a flow diagram 800 showing processing steps in connection with non-contact control of a dialysis machine by a user with an interface device, like that described herein, for example, in connection with the interface device 401, 402, paired or otherwise coupled to the dialysis machine according to an embodiment of the system described herein. At a step 802, in response to a user action, such as pressing a button, the interface device transmits a control signal to a dialysis machine, like the dialysis machine 22 or 102, that is performing a dialysis treatment on a patient. In an embodiment, the interface device may be a device held by a user, such as an HCP who is monitoring the dialysis treatment, and/or may be a device positioned on the floor that is engaged by the foot of the HCP. In this way, the HCP does not physically contact the display or other components of the dialysis machine. After the step 802, processing proceeds to a step 804 where the wireless signal transmitted by the interface device is received by a sensor of the dialysis machine. After the step 804, processing proceeds to a step 806 where the received wireless signal is processed in connection with control of one or more screens displayed on the display of the dialysis machine during the dialysis treatment.

After the step 806, processing proceeds to a step 808 where information displayed on the display of the dialysis machine during the dialysis treatment is modified based on the wireless signal received. For example, as discussed elsewhere herein, the instruction sent from the interface device as a wireless signal, may enable navigation through screens displayed on the display of the dialysis machine in a pre-ordered manner and further enabling cycling through activatable portions of particular screens until selection of a particular portion of the displayed screen. After the step 808, processing is complete for the described processing iteration of the interface device. It is noted that the processing of the flow diagram 800 may be an on-going process in which the interface device continuously transmits wireless signals in response to user action, such as pressing buttons on the interface device. It is noted that the processing steps performed in the flow diagram 800 may be performed in connection with the execution of software on a non-transitory computer-readable medium of the interface device by one or more processors of the interface device and/or execution of software on a non-transitory computer readable medium of a sensor of the dialysis machine by one or more processors of the sensor. In an embodiment, the software may correspond to software that facilitates and/or otherwise interfaces with the dialysis machine in connection with the performance of the dialysis treatment, such as by providing one or more dialysis treatment screens.

FIG. 12 is a flow diagram 820 showing processing steps for command recognition and information transmission processing in connection with the use of a command recognition device, like that described herein, for example, in connection with the command recognition device 142 of the sensor 145 of dialysis machine 102, according to another embodiment of the system described herein. In an embodiment, the processing of the flow diagram 820 may be alternative to, or in addition to, the processing of the flow diagram 800. At a step 822, the command recognition device recognizes an input command by the user (HCP). In various embodiments, the input command may be a gesture and/or a voice command that is recognized by the command recognition device. After the step 822, processing proceeds to a step 824 where the input command recognized by the command recognition device is processed in connection with information being displayed on the display of the dialysis machine.

After the step 824, processing proceeds to a step 826 where information displayed on the display of the dialysis machine during the dialysis treatment is modified based on the wireless signal received. For example, as discussed elsewhere herein, the instruction sent from the interface device as a wireless signal, may enable navigation through screens displayed on the display of the dialysis machine in a pre-ordered manner and further enabling cycling through activatable portions of particular screens until selection of a particular portion of the displayed screen. After the step 826, processing is complete for the described processing iteration of the interface device. It is noted that the processing of the flow diagram 820 may be an on-going process in which the interface device continuously transmits wireless signals in response to user action, such as pressing buttons on the interface device. It is noted that the processing steps performed in the flow diagram 820 may be performed in connection with the execution of software on a non-transitory computer-readable medium of the interface device by one or more processors of the command recognition device and/or execution of software on a non-transitory computer readable medium of a sensor of the dialysis machine by one or more processors of the sensor. In an embodiment, the software may correspond to software that facilitates and/or otherwise interfaces with the dialysis machine in connection with the performance of the dialysis treatment, such as by providing one or more dialysis treatment screens.

FIG. 13 is a flow diagram 900 showing processing in connection with navigating and/or activating screens of a display of a dialysis machine, like the dialysis machine 22 or 102, during a dialysis treatment according to an embodiment of the system described herein. At a step 902, a screen is displayed on the display of the dialysis machine. After the step 902, processing proceeds to step 904 where an input command is received from a user. For example, the input command may be in the form of a wireless signal sent from an interface device, such as the interface device 401 or 402 and/or the instruction may be in the form of a non-contact command, such as a gesture and/or voice-based command that is recognized by a command recognition device coupled to the dialysis machine. In various embodiments, a sensor of the dialysis machine, like that of the sensor 40, 140 or 140′ discussed herein, may process the signal and/or recognized command received in connection with the operation of the dialysis machine and/or dialysis treatment.

After the step 904, processing proceeds to a test step 906 where it is determined whether the input command received from a user that includes instructions to navigate from a current screen of information to a different screen of information displayed on the display of the dialysis machine. If, at the test step 906, it is determined that input command is to navigate to a different screen, then processing proceeds to a step 908 where a next screen of information is displayed on the display of the dialysis machine. In an embodiment, the next screen of information displayed may be pre-defined, thereby enabling a user to cycle through screens by pressing a button of the interface device and/or by providing gesture or voice command. In other embodiments, different buttons, gestures and/or voice commands may be pre-assigned to specific pre-defined screens, thereby enabling the user to directly go to a particular screen. After the step 908, processing is complete for the current iteration of the process being discussed, noting that the processing of the flow diagram 900 may be a repeatedly processed.

If, at the test step 906, it is determined that the input command is not directed to navigating to a different screen, then processing proceeds to a test step 910 where it is determined whether the input command is directed to activation of a section of the current screen being displayed on the display of the dialysis machine. If, not, then processing proceeds to a step 912 where other processing is performed with respect to the input command, and thereafter, processing is complete. If, at the test step 910, it is determined that the input command is to select and/or activate a section of the current screen, such as a button displayed on the screen in connection with a dialysis treatment screen, then processing proceeds to a step 914, where the input command is processes to select/activate the appropriate section. In various embodiments, the selection/activation may include iterations of cycling through activatable sections of the current screen and/or buttons on the interface device and/or specific gestures or voice commands may enable direct selection of a button on the current displayed screen.

After the step 914, processing proceeds to a step 916 where the selected portion of the screen is activated (e.g., button on the display is activated) and the current screen information is updated to reflect the activated button. For example, the received control activation command may have adjusted a parameter of the dialysis treatment being performed and the confirmation is updated information of the dialysis treatment that is transmitted to the interface device. The updated information may therefore correspond to a treatment screen of the dialysis treatment displayed on the dialysis machine. After the step 914, processing is complete for the current iteration of the processing being described. It is noted that the processing of the flow diagram 900 may be an on-going process in which the dialysis machine repeatedly processes monitors for input commands and/or signals in connection with the system described herein. It is noted that the processing steps performed in the flow diagram 900 may be performed in connection with the execution of software on a non-transitory computer-readable medium of the dialysis machine by one or more processors of the dialysis machine, including, in particular, one or more processors of a sensor of the dialysis machine. In an embodiment, the software may correspond to software that facilitates and/or otherwise interfaces with an interface device specifically in connection with non-contact monitoring and control of the dialysis treatment, such as in connection with the providing of dialysis treatment screens. It is noted that the processing of the flow diagram 900 may be performed in conjunction with other processing of the dialysis machine, including for example, input of commands directly to the dialysis machine via a touch screen display, for example.

It is noted that the system described herein is discussed principally in connection with the use of dialysis machines and treatments. It is noted that, in other embodiments, the system described herein may also be used in connection with other medical devices where wireless, non-contact control of such devices may be appropriately performed. It is also noted that the system described herein may be used in connection and conjunction with the features and functions of a system like that described in the application filed concurrently herewith to Christensen, entitled “Wearable Interface for Remote Monitoring and Control of a Medical Device,” having Attorney Docket No. FRM-002US, which is assigned to the same assignee as that of the present application and which is incorporated herein by reference.

Various embodiments discussed herein may be combined with each other in appropriate combinations in connection with the system described herein. Additionally, in some instances, the order of steps in the flowcharts, flow diagrams and/or described flow processing may be modified, where appropriate. Further, various aspects of the system described herein may be implemented using software, hardware, a combination of software and hardware and/or other computer-implemented modules or devices having the described features and performing the described functions. Software implementations of the system described herein may include executable code that is stored in a computer-readable medium and executed by one or more processors. The computer-readable medium may include volatile memory and/or non-volatile memory, and may include, for example, a computer hard drive, ROM, RAM, flash memory, portable computer storage media such as a CD-ROM, a DVD-ROM, a flash drive and/or other drive with, for example, a universal serial bus (USB) interface, and/or any other appropriate tangible or non-transitory computer-readable medium or computer memory on which executable code may be stored and executed by a processor. The system described herein may be used in connection with any appropriate operating system.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A method of non-contact interfacing with a medical device, comprising:
providing a first device that enables non-contact interfacing with the medical device by a user;
receiving a command signal from the user at the medical device, wherein the command signal corresponds to a treatment performed using the medical device, wherein the command signal is a non-contact command received from the user without physical contact of the user with the medical device;
processing the command signal at the medical device to generate information corresponding to the treatment performed using the medical device; and
displaying the information on a screen of the medical device.

2. The method according to claim 1, wherein the medical device includes a dialysis machine, and wherein the information displayed on the screen of the medical device includes dialysis treatment information displayed during a dialysis treatment.

3. The method according to claim 1, wherein the first device includes an interface device that transmits a wireless signal to the medical device in response to an action by the user.

4. The method according to claim 1, wherein the non-contact command causes a change in the information being displayed on the screen of the medical device.

5. The method according to claim 4, wherein change in the information being displayed on the screen of the medical device includes a different screen being displayed on the medical device.

6. The method according to claim 4, wherein the change in the information being displayed on the screen of the medical device includes a section of the information being activated by the non-contact command.

7. The method according to claim 1, further comprising:
recognizing a gesture of the user using a command recognition device coupled to the dialysis machine as the command signal.

8. The method according to claim 1, further comprising:
recognizing a voice command of the user using a command recognition device coupled to the dialysis machine as the command signal.

9. A non-transitory computer-readable medium storing software for non-contact interfacing with a medical device, comprising:
executable code that operates a first device that enables non-contact interfacing with the medical device by a user;
executable code that receives a command signal from the user at the medical device, wherein the command signal corresponds to a treatment performed using the medical device, wherein the command signal is a non-contact command received from the user without physical contact of the user with the medical device;
executable code that processes the command signal at the medical device to generate information corresponding to the treatment performed using the medical device; and
executable code that displays the information on a screen of the medical device.

10. The non-transitory computer-readable medium according to claim 9, wherein the medical device includes a dialysis machine, and wherein the information displayed on the screen of the medical device includes dialysis treatment information displayed during a dialysis treatment.

11. The non-transitory computer-readable medium according to claim 9, wherein the first device includes an interface device that transmits a wireless signal to the medical device in response to an action by the user.

12. The non-transitory computer-readable medium according to claim 9, wherein the non-contact command causes a change in the information being displayed on the screen of the medical device.

13. The non-transitory computer-readable medium according to claim 12, wherein change in the information being displayed on the screen of the medical device includes a different screen being displayed on the medical device.

14. The non-transitory computer-readable medium according to claim 12, wherein the change in the information being displayed on the screen of the medical device includes a section of the information being activated by the non-contact command.

15. The non-transitory computer-readable medium according to claim 9, where the software further comprises:
executable code that recognizes a gesture of the user using a command recognition device coupled to the dialysis machine as the command signal.

16. The non-transitory computer-readable medium according to claim 9, wherein the software further comprises:
executable code that recognizes a voice command of the user using a command recognition device coupled to the dialysis machine as the command signal.

17. A system for enabling non-contact interfacing with a dialysis machine, comprising:
at least one sensor of the dialysis machine that receives signals corresponding to a dialysis treatment performed by the dialysis machine;
a first device that is communicationally coupled to the at least one sensor, wherein the first device includes at least one component that processes received signals into information corresponding to the dialysis treatment; and
at least one screen that displays the information corresponding to the dialysis treatment.

18. The system according to claim 17, wherein the first device includes an interface device that transmits a wireless signal to the medical device in response to an action by the user, wherein the wireless signal includes a command signal that causes a change in the information being displayed on the screen of the medical device.

19. The system according to claim 18, wherein the change in the information being displayed on the screen of the medical device includes at least one of: (i) a different screen being displayed on the medical device, or (ii) a section of the information being activated by the non-contact command.

20. The system according to claim 17, wherein the first device includes a command recognition device that performs at least one of: (i) recognizing a gesture of the user a command recognition as the command signal, or (ii) recognizing a voice command of the user as the command signal.
